(19) United States
(12) Patent Application Publication
(10) Pub. No.: US 2007/0115201 A1
(43) Pub. Date: May 24, 2007

(54) Antenna system and radio communication unit

(75) Inventor: Kiyoshige Nakamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 10/586,322

(22) PCT Filed: Jan. 16, 2004
(86) PCT No.: PCT/JP04/00269

§ 371 Date: Jul. 14, 2006

(51) Int. Cl. H01Q 1/12

(52) U.S. Cl. 343/890; 343/891

(57) ABSTRACT

An antenna device 10 comprises azimuthal range (“sector”) antennas in which an upward directivity antenna 21 is paired with a downward directivity antenna 22, and different sector antennas in which an upward directivity antenna 23 is paired with a downward directivity antenna 24. The upward directivity antennas 21 and 23 are the antennas upwardly directed toward a tilt-angle range, and the downward directivity antennas 22 and 24 are the antennas downwardly directed toward a tilt-angle range. The sector antennas are the antennas for transmitting and receiving radio signals from azimuthal ranges (sectors) being a fill sweep divided into three or more, and the two pairs each are disposed horizontally in an individual sector. By providing these configurations, while efficiently utilizing their installation space, effectiveness of diversity can be enhanced.

### TECHNICAL FIELD

The present invention relates to antenna devices utilizing azimuthal range antennas for transmitting and receiving radio signals, corresponding to each predetermined azimuthal range, and to radio communications apparatuses provided with the antenna devices.

### BACKGROUND ART

A conventional antenna device, for example, an antenna device disclosed in Japanese Patent Laid-Open No. 1991-038933, is applicable to a base station for mobile communications; the antenna device consists of a first antenna and a second antenna used for space diversity.

Another antenna device, as disclosed, for example, in Japanese Patent Laid-Open No. 1993-063634, is applicable to a base station for mobile communications; the antenna device includes a first antenna corresponding to an entire radio range, and a second antenna capable of tilting the directivity thereof along vertical surface electrically or physically to depression angle direction.

In the case of these conventional antenna devices, when the number of antennas is intended to increase so as to enhance effectiveness of diversity, simply increasing the number of antennas has caused a problem in that installation space will only increase in vain.

### DISCLOSURE OF THE INVENTION

An object of the invention is to provide an antenna device and a radio communications apparatus of which effectiveness of diversity can be maintained, or can be further enhanced while efficiently utilizing their installation space.

In one aspect of this invention, an antenna device includes azimuthal range antennas for transmitting and receiving radio signals from azimuthal ranges being a full sweep divided into three or more; the azimuthal range antennas are two or more, rowed horizontally in each of the azimuthal ranges; the antenna device is characterized in that the azimuthal range antennas are tilt-angle directivity antennas directed toward two or more tilt-angle ranges.

According to this invention, by horizontally disposing two or more azimuthal range antennas and, by having the azimuthal range antennas to perform tilt-angle directivity antennas directed toward two or more tilt-angle ranges; namely, by combining space diversity with directivity diversity, while efficiently utilizing their installation space, effectiveness of diversity can be further enhanced.

In another aspect of this invention, an antenna device includes azimuthal range antennas for transmitting and receiving radio signals from azimuthal ranges being a full sweep divided into three or more; the azimuthal range antennas are directed toward each of the azimuthal ranges; the antenna device is characterized in that: the azimuthal range antennas are tilt-angle directivity antennas directed toward two or more tilt-angle ranges; and simultaneously, comprises a common mast for unitarily supporting an azimuthal range antenna corresponding to an adjoining azimuthal range.

According to this invention, by directing, as tilt-angle directivity antennas, the azimuthal range antennas toward two or more tilt-angle ranges, while maintaining effectiveness of directivity diversity, a common mast unitarily supports an azimuthal range antenna individually corresponding to a mutually adjoining azimuthal range, so that their installation space can be utilized efficiently.

In yet another aspect of this invention, a radio communications apparatus includes: an antenna device having azimuthal range antennas for transmitting and receiving radio signals from azimuthal ranges being a full sweep divided into three or more, and the azimuthal range antennas are two or more, rowed horizontally in each of the azimuthal ranges; and a receiving device for processing the signals having received by way of the antenna device; the radio communications apparatus is characterized in that the azimuthal range antennas are tilt-angle directivity antennas directed toward two or more tilt-angle ranges.

According to a radio communications apparatus in the present invention, similarly to the antenna device described above, while efficiently utilizing its installation space, effectiveness of diversity can be further enhanced.

### BRIEF DESCRIPTION OF DRAWINGS

FIG. 1 is a diagram showing a schematic configuration of a radio communications apparatus in Embodiment 1 of the present invention;

FIG. 2 is a plan view showing a schematic layout of an antenna device in Embodiment 1;

FIG. 3 is a diagram showing tilt-angle directivities of the antenna device in Embodiment 1;

FIG. 4 is a diagram showing a schematic configuration of a radio communications apparatus related to a comparative example 1;

FIG. 5 is a plan view showing a schematic layout of an antenna device related to the comparative example 1;

FIG. 6 is a diagram showing a schematic configuration of a radio communications apparatus in Embodiment 2 of the present invention;

FIG. 7 is a plan view showing a schematic layout of an antenna device in Embodiment 2;

FIG. 8 is a diagram showing an electrical configuration of an antenna device in Embodiment 3 of the present invention;

FIG. 9 is a diagram showing a schematic configuration of a radio communications apparatus in Embodiment 3;

FIG. 10 is a diagram showing a schematic configuration of a radio communications apparatus in Embodiment 4 of the present invention;

FIG. 11 is a diagram showing a schematic configuration of a radio communications apparatus in Embodiment 5 of the present invention;

FIG. 12 is a view showing a schematic configuration of an antenna device in Embodiment 6 of the present invention; and

FIG. 13 is a view showing a schematic configuration of an antenna device related to a comparative example 2.

### BEST MODE FOR CARRYING OUT THE INVENTION

### Embodiment 1.

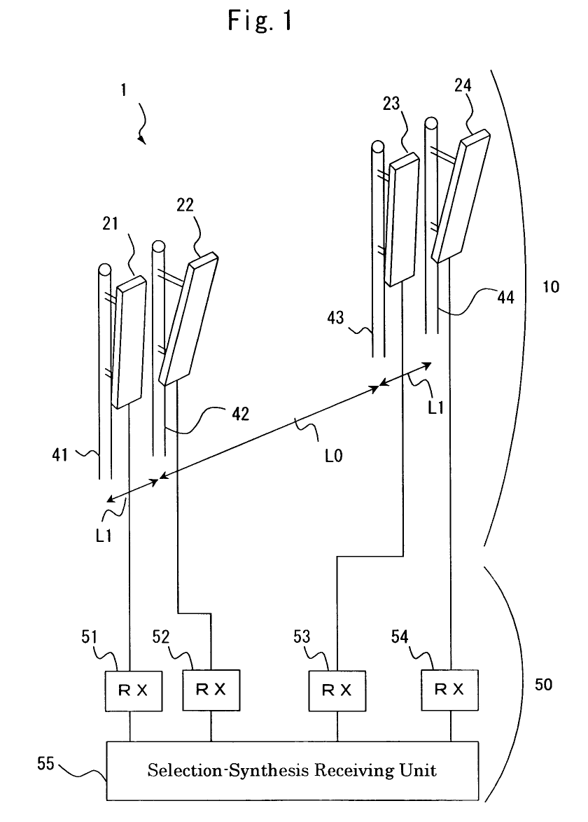

FIG. 1 is a diagram showing a schematic configuration of a radio communications apparatus in Embodiment 1 of the present invention. The radio communications apparatus 1, which comprises an antenna device 10 and a receiving device 50, for example, in a mobile communication systems, is applicable to a base station that radio-communicates with mobile communications terminals.

The antenna device 10 comprises upward directivity antennas 21 and 23, downward directivity antennas 22 and 24, and supporting masts 41 through 44. The upward directivity antenna 21 is an antenna upwardly directed toward a tilt-angle range, and is supported by the mast 41. The downward directivity antenna 22 is an antenna downwardly directed toward a tilt-angle range, and is supported by the mast 42. The upward directivity antenna 23 is an antenna upwardly directed toward a tilt-angle range, and is supported by the mast 43. The downward directivity antenna 24 is an antenna downwardly directed toward a tilt-angle range, and is supported by the mast 44.

In these antennas, the upward directivity antenna 21 is paired with the downward directivity antenna 22, and form a sector antenna for receiving radio signals in an azimuthal range (hereinafter referred to as “a sector”), in which the whole azimuthal angle covering the perimeter of the radio communications apparatus has been equally divided into three. Similarly, the upward directivity antenna 23 is paired with the downward directivity antenna 24, and form a sector antenna. In FIG. 1, a schematic configuration corresponding only to a single sector is illustrated. The upward directivity antennas 21 and 23 are antennas (upwardly) directed toward the same tilt-angle range; in order to obtain effectiveness of space diversity, they are disposed apart from each other in horizontal directions, by a distance L0 in accordance with radio frequencies. Similarly, the downward directivity antennas 22 and 24 are antennas (downwardly) directed toward the same tilt-angle range; in order to obtain effectiveness of space diversity, they are disposed apart from each other in horizontal directions, by a distance L0 in accordance with radio frequencies. The distance L0 in accordance with mutual radio frequencies is, to be specific, a distance larger than the wavelengths of radio carrier waves.

On the other hand, because the upward directivity antenna 21 and the downward directivity antenna 22 can unitarily obtain effectiveness of directivity diversity, these antennas can be disposed in a proximal distance (a distance L1). Similarly, because the upward directivity antenna 23 and the downward directivity antenna 24 can unitarily obtain effectiveness of directivity diversity, these antennas can also be disposed in a proximal distance (a distance L1). As described above, by combining the space diversity with the directivity diversity, effectiveness of diversity can be enhanced while efficiently utilizing the installation space.

The receiving device 50 comprises radio receivers (RX) 51 through 54, and a selection-synthesis receiving unit 55. The radio receiver 51 converts high-frequency signals received by the upward directivity antenna 21, into baseband signals. Similarly, the radio receivers 52 through 54 convert high-frequency signals received by the directivity antennas 22 through 24, into baseband signals, respectively. Based on the signals having obtained by way of each of the directivity antennas 21 through 24, the selection-synthesis receiving unit 55 determines receiving signals by performing selection or synthesis processing.

The selection or synthesis processing performed by the selection-synthesis receiving unit 55 has the following types with respect to each of the space diversity and the directivity diversity.

To begin with, in the case of the pair of upward directivity antennas 21 and 23 that performs space diversity, there exist a selection type that selects either of the signals having good receiving quality, and a synthesis type that synthesizes two signals. The former has an advantage of removing influence caused by the signals having poor receiving quality; the latter has an advantage of compensating one signal with the other signal when a receiving level is locally lowered by such as fading. Similarly, in the case of the pair of downward directivity antennas 22 and 24 that performs space diversity, there exist a selection type and a synthesis type, and the advantages are also similar. Moreover, a selection-synthesis type that selects either the selection type or the synthesis type is also applicable. The selection-synthesis type has both the advantages the selection type and the synthesis tape have.

In the cases of the pair of upward directivity antenna 21 and downward directivity antenna 22 that performs directivity diversity, and the pair of upward directivity antenna 23 and downward directivity antenna 24, there exist a selection type that selects either of the signals with good receiving quality, and a synthesis type that synthesizes two signals. The selection type has an advantage of removing influence caused by the signals with poor receiving quality. To be more specific in explanation, when a communications party is present at an outer area in the communicable area covered by the radio communications apparatus 1, signals with higher gain from the upward directivity antenna can be selected, and signals with low gain and picked-up noise from the downward directivity antenna can be removed. On the contrary, when the communications party is present within an inner area of the communicable area, signals with higher gain from the downward directivity antenna can be selected, and signals with low gain and picked-up noise from the upward directivity antenna can be removed. When the communications party is present near the boundary between the outer area and the inner area of the communicable area, the synthesis type synthesizes both the signal with lowered gain from the upward directivity antenna and the signal with lowered gain from the downward directivity antenna, so as to compensate with each other; thus signals with high gain can be received. Moreover, similarly to the case of space diversity, the selection-synthesis type is also applicable.

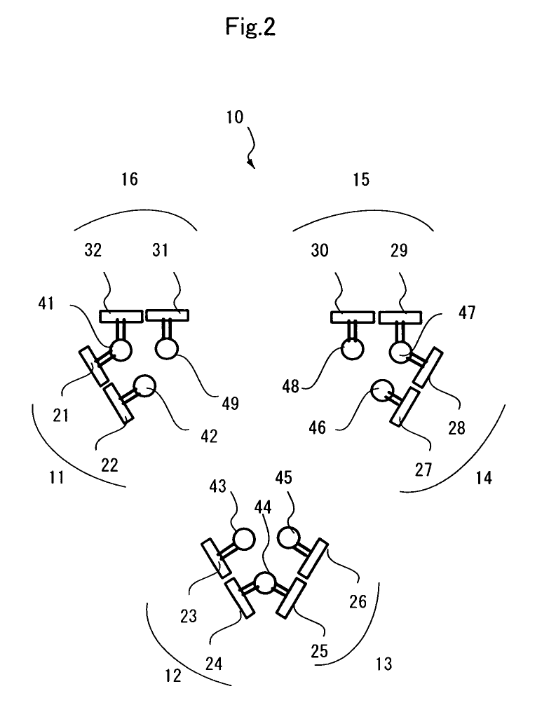

FIG. 2 is a plan view showing a schematic layout of the antenna device in Embodiment 1. In addition to the upward directivity antennas 21 and 23, the downward directivity antennas 22 and 24, and the masts 41 through 44, explained referring to FIG. 1, the antenna device 10 comprises upward directivity antennas 25, 27, 29 and 31, downward directivity antennas 26, 28, 30 and 32, and masts 45 through 49. Among these items, the upward directivity antenna 21 and the downward directivity antenna 22 illustrated in FIG. 1 compose a first sector antennas 11, and the upward directivity antenna 23 and the downward directivity antenna 24 compose a first sector antennas 12. Similarly, the upward directivity antenna 25 and the downward directivity antenna 26 compose a second sector antennas 13, and the upward directivity antenna 27 and the downward directivity antenna 28 compose a second sector antennas 14. Similarly again, the upward directivity antenna 29 and the downward directivity antenna 30 compose a third sector antennas 15, and the upward directivity antenna 31 and the downward directivity antenna 32 compose a third sector antennas 16.

As illustrated in FIG. 1, the mast 44 supports the downward directivity antenna 24, as well as the upward directivity antenna 25. The mast 45 supports the downward directivity antenna 26. The mast 46 supports the upward directivity antenna 27. The mast 47 supports not only the downward directivity antenna 28, but also the upward directivity antenna 29. The mast 48 supports the downward directivity antenna 30. The mast 49 supports the upward directivity antenna 31. As illustrated in FIG. 1, the mast 41 supports the upward directivity antenna 21, as well as the downward directivity antenna 32.

The first sector antennas 11 and 12, the second sector antennas 13 and 14, and the third sector antennas 15 and 16, are disposed in such a way that each pair draws each side of a triangle. Accordingly, the masts 41 through 49 are disposed to draw a triangle; in particular, the masts 41, 44 and 47 that commonly support two directivity antennas, are disposed at each vertex of the triangle drawn by the masts 41 through 49.

With reference to FIG. 1, it has been described that, while separately disposing the first sector antennas 11 and 12 apart, the upward directivity antenna 21 and the downward directivity antenna 22 can be disposed in a proximal distance, and the upward directivity antenna 23 and the downward directivity antenna 24 can be disposed in a proximal distance, which is the same as the case with the antennas corresponding to the second sector antennas and the third sector antennas, respectively. Therefore, as shown in FIG. 2, the antenna device 10 can be installed by only allocating adequate spaces at three locations, so that space-utilizing efficiency can be increased.

Moreover, because the masts 41, 44 and 47 are commonly used in each sector adjoining to each other, from an aspect of installation of the antenna device 10, space-utilizing efficiency can be further increased.

Furthermore, with reference to FIG. 2, although a configuration of the antenna device 10 corresponding to all the sectors has been described, the configuration of the receiving device 50 shown in FIG. 1 only corresponds to the first sector, and an actual receiving device 50, similarly corresponding to the second sector and the third sector, has a configuration similar to that of FIG. 1; namely, the configuration includes radio receivers and a selection-synthesis receiving unit.

Still furthermore, with reference to FIG. 1 and FIG. 2, corresponding to the three sectors, the antenna device and the radio communications apparatus are shown having two pairs of sector antennas in each sector, and directed toward two pairs of tilt-angle ranges; however, these are not the only cases, so that, corresponding to four or more than four sectors, expansion is possible in configurations having three or more than three pairs of sector antennas in each sector, and directed toward three or more than three pairs of tilt-angle ranges.

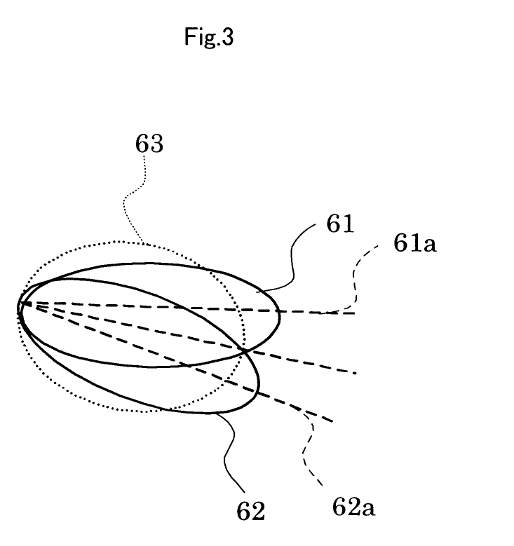

FIG. 3 is a diagram showing tilt-angle directivities of the antenna device in Embodiment 1. The tilt angle is an angle in the vertical plane including the antenna device 10 with respect to the horizontal directions. A curve 61 shows an antenna gain in relation to the tilt angle of the upward directivity antenna. A curve 62 shows an antenna gain in relation to the tilt angle of the downward directivity antenna. A curve 63 shows an antenna gain of the antenna covering both the upward and downward tilt-angle ranges.

The curve 61 forms an elliptical shape having a specific center axis (the major axis 61a). Therefore, the antenna gain obtained by the upward directivity antenna demonstrates a directivity within a narrow tilt-angle range centered on the major axis 61a including the tilt angle. Similarly, the curve 62 forms an elliptical shape having a specific center axis (the major axis 62a). Therefore, the antenna gain obtained by the downward directivity antenna demonstrates a directivity within a narrow tilt-angle range centered on the major axis 62a including the tilt angle. The tilt angle of the major axis 61a is smaller than that of the major axis 62a, and is close to be horizontal. Based on these tilt-angle directivities, the radio communications apparatus 1 can radio-communicate with a distant communications party by mainly using the upward directivity antennas, and with a near communications party by mainly using the downward directivity antennas.

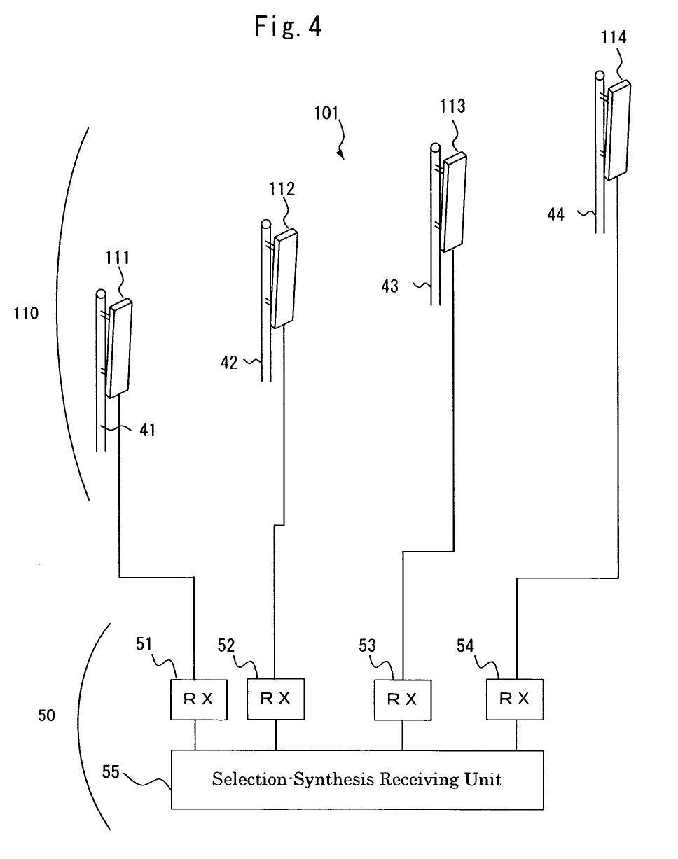

FIG. 4 is a diagram showing a schematic configuration of a radio communications apparatus related to a comparative example 1. The radio communications apparatus 101, in comparison with the radio communications apparatus 1 shown in FIG. 1, replaces the antenna device 10 with an antenna device 110. As far as other configurations are concerned, the same reference numerals and symbols are designated and their explanation is thus omitted, and a configuration of the antenna device 110 is described. The antenna device 110 includes a first sector antennas 111 through 114, and masts 41 through 44. The first sector antennas 111 through 114 do not in particular have tilt-angle directivities, but are disposed at predetermined intervals based on each radio frequencies.

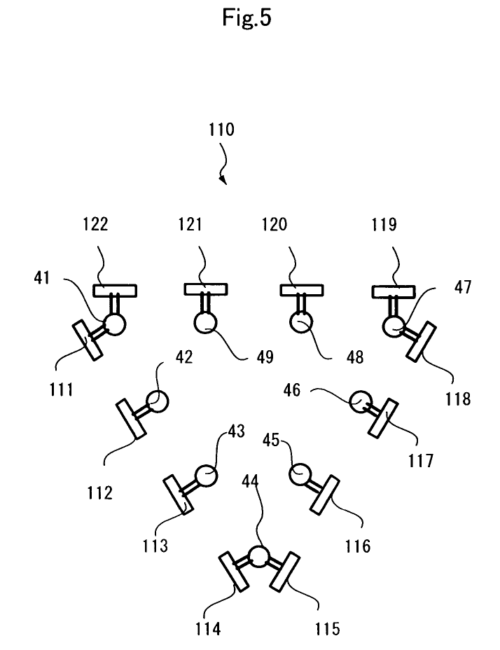

FIG. 5 is a plan view showing a schematic layout of the antenna device related to the comparative example 1. In addition to the first sector antennas 111 through 114, and the masts 41 through 44, as illustrated in FIG. 4, the antenna device 110 includes second sector antennas 115 through 118, third sector antennas 119 through 122, and masts 45 through 49.

When the above-described radio communications apparatus 101 related to the comparative example 1 is compared with the radio communications apparatus 1 in Embodiment 1, the comparative example 1 only performs space diversity by simply disposing four sector antennas for each individual sector, meanwhile, Embodiment 1 combines space diversity with directivity diversity together for each individual sector; therefore installation-space utilizing efficiency is high.

### Embodiment 2.

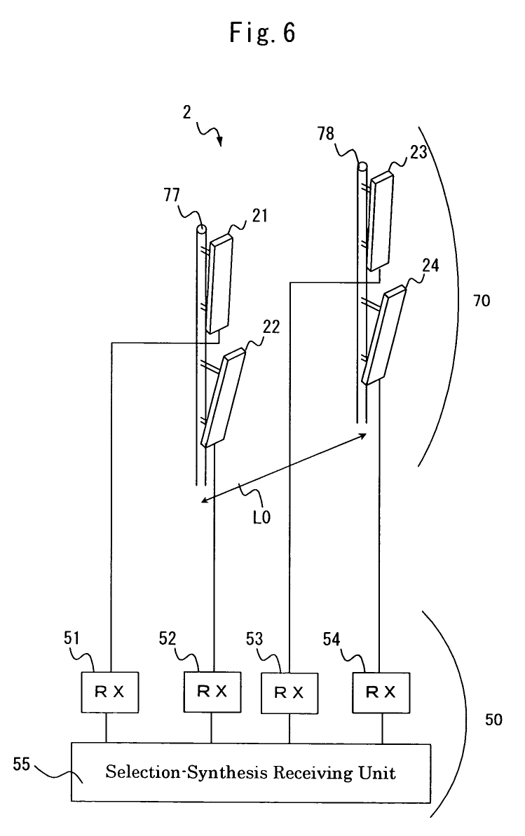

FIG. 6 is a diagram showing a schematic configuration of a radio communications apparatus in Embodiment 2 of the present invention. The radio communications apparatus 2, in the radio communications apparatus 1 shown in FIG. 1, replaces the antenna device 10 with an antenna device 70. In the case of the antenna device 70, a common mast 77 supports both the upward directivity antenna 21 and the downward directivity antenna 22, which are individually supported by each mast in the antenna device 10; and similarly, a common mast 78 supports both the upward directivity antenna 23 and the downward directivity antenna 24. On the mast 77, the upward directivity antenna 21 is disposed above the downward directivity antenna 22, and on the mast 78, the upward directivity antenna 23 is disposed above the downward directivity antenna 24, respectively. Because other configurations are the same as those of the radio communications apparatus 1 shown in FIG. 1, the same reference numerals and symbols are designated, and their explanation is thus omitted.

As described above, when an antenna device is installed by supporting both the upward directivity antenna and downward directivity antenna on a common mast, space-utilizing efficiency can be further increased.

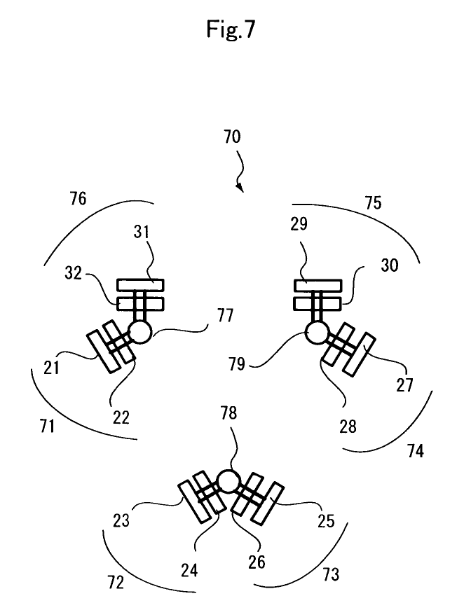

FIG. 7 is a plan view showing a schematic layout of the antenna device in Embodiment 2. In addition to the upward directivity antennas 21 and 23, the downward directivity antennas 22 and 24, and the masts 77 and 78, explained referring to FIG. 6, the antenna device 70 comprises upward directivity antennas 25, 27, 29 and 31, downward directivity antennas 26, 28, 30 and 32, and a mast 79. Among those, as explained in FIG. 6, the upward directivity antenna 21 and the downward directivity antenna 22 compose a first sector antennas 71, and the upward directivity antenna 23 and the downward directivity antenna 24 compose a first sector antennas 72. Similarly, the upward directivity antenna 25 and the downward directivity antenna 26 compose a second sector antennas 73, and the upward directivity antenna 27 and the downward directivity antenna 28 compose a second sector antennas 74. Similarly again, the upward directivity antenna 29 and the downward directivity antenna 30 compose a third sector antennas 75, and the upward directivity antenna 31 and the downward directivity antenna 32 compose a third sector antennas 76.

As explained in FIG. 6, the mast 78 supports the first sector antennas 72, as well as the second sector antennas 73. The mast 79 supports the second sector antennas 74, as well as the third sector antennas 75. As explained in FIG. 6, the mast 77 supports the first sector antennas 71, as well as the third sector antennas 76.

The first sector antennas 71 and 72, the second sector antennas 73 and 74, and the third sector antennas 75 and 76, are disposed in such a way that each pair draws each side of a triangle. In accordance with the above, the masts 77 through 79 are disposed at each vertex of the triangle.

As described above, by supporting sector antennas corresponding to each sector, together with sector antennas corresponding to adjoining sectors, on a common mast, as well as by supporting upward directivity antennas and downward directivity antennas on the common mast, an antenna device can be installed by using only three masts, so that space-utilizing efficiency can be further increased.

### Embodiment 3.

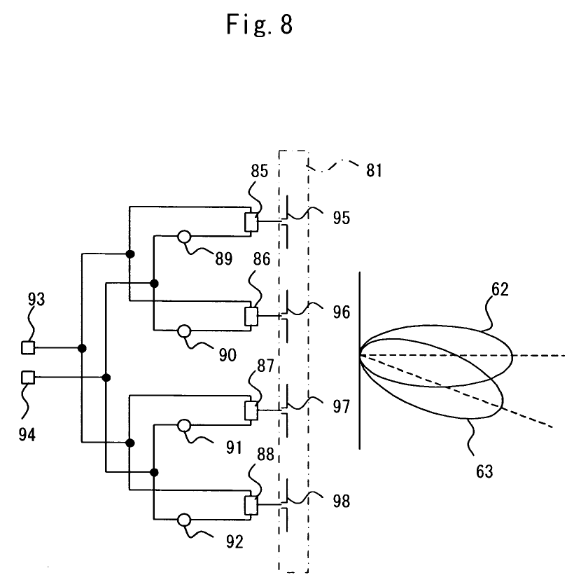

FIG. 8 is a diagram showing an electrical configuration of an antenna device in Embodiment 3 of the present invention. The antenna device 80 unifies, as a common single first-sector antenna 81, the upward directivity antenna 21 and the downward directivity antenna 22 that are individually used in the antenna device 70 shown in FIG. 6. The antenna device 80 comprises the first sector antenna 81, dividers 85 through 88, phase correctors 89 through 92, and output connectors 93 and 94. The first sector antenna 81 includes antenna elements 95 through 98 that are disposed in vertical directions, and are individually capable of receiving radio signals. Each of the dividers 85 through 88 distributes the signals from the antenna elements 95 through 98 into two signals of the same, respectively. One of the signal lines being outputted from each of the dividers 85 through 88 is connected to the output connector 93 without passing through the phase correctors. The other of the signal lines being outputted from each of the dividers 85 through 88 is connected to the output connector 94 by way of the phase correctors 89 through 92, respectively.

As described above, because, on one hand, each signal from the antenna elements 95 through 98 is synthesized maintaining the same phase without phase correction and is outputted from the connector 93, and on the other hand, each signal from the antenna elements 95 through 98 is synthesized with the phase shifted after the phase having been corrected, and is outputted from the connector 94, by using the single directivity antenna 81, receiving signals directed toward two tilt-angle ranges can be outputted. By using these characteristics, the same tilt-angle directivities shown in FIG. 3 can be achieved.

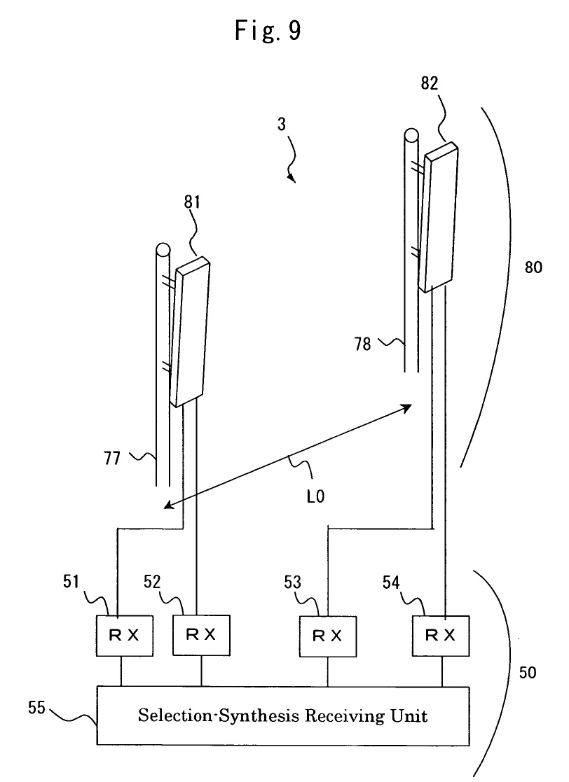

FIG. 9 is a diagram showing a schematic configuration of a radio communications apparatus in Embodiment 3. The radio communications apparatus 3, in the radio communications apparatus 2 shown in FIG. 6, replaces the antenna device 70 with the antenna device 80. In FIG. 8, the configuration is graphically shown by referring to the first sector antenna 81 alone; however, in an actual case, the antenna device 80 also comprises another first-sector antenna 82 corresponding to the first sector antenna. Moreover, two sector antennas are individually provided for the second sector and the third sector each.

By taking these configurations, upward directivity antennas and downward directivity antennas can be integrated together for each of the sector antennas; thus, installation space for the antennas can be reduced.

### Embodiment 4.

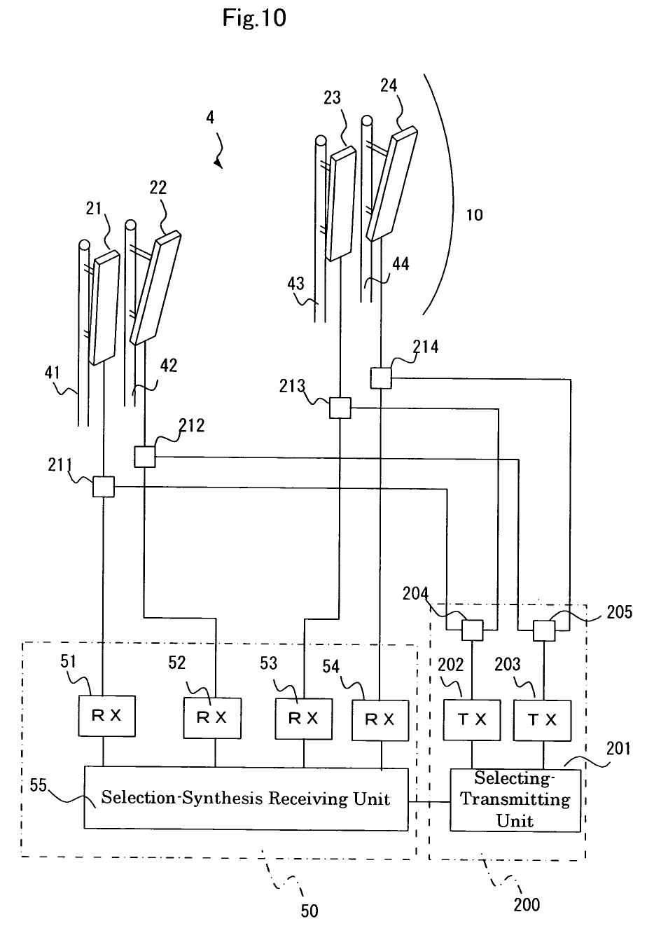

FIG. 10 is a diagram showing a schematic configuration of a radio communications apparatus in Embodiment 4 of the present invention. A radio communications apparatus 4 is configured by adding a transmitting device 200 and duplexers 211 through 214 to the radio communications apparatus 1 shown in FIG. 1. For the same configurations as in the radio communications apparatus 1, the same reference numerals and symbols are designated and their explanation is omitted; thus, explanations are given as below to other configurations that differ from those of the radio communications apparatus 1.

The transmitting device 200 comprises a selecting-transmitting unit 201, radio transmitters (TX) 202 and 203, and dividers 204 and 205. Following an instruction given from the selection-synthesis receiving unit 55 in the receiving device 50, the selecting-transmitting unit 201 selects either upward or downward, or both tilt-angle directivities; baseband transmitting signals are outputted to the radio transmitter 202 or the radio transmitter 203 corresponding to the tilt-angle directivity. Both the radio transmitters 202 and 203 convert the baseband transmitting signals given from the selecting-transmitting unit 201 into high-frequency-band signals capable of radio transmission. On one hand, the radio transmitter 202, which is connected to the upward directivity antenna 21 by way of the divider 204 and the duplexer 211, and is also connected to the upward directivity antenna 23 by way of the divider 204 and the duplexer 213, therefore, corresponds to upward directivity. On the other hand, the radio transmitter 203, which is connected to the downward directivity antenna 22 by way of the divider 205 and the duplexer 212, and is also connected to the downward directivity antenna 24 by way of the divider 205 and the duplexer 214, therefore, corresponds to downward directivity. The divider 204 distributes the high-frequency signals having been outputted from the radio transmitter 202 to the upward directivity antenna 21 and the upward directivity antenna 23. The divider 205 distributes the high-frequency signals having been outputted from the radio transmitter 203 to the upward directivity antenna 22 and the upward directivity antenna 24.

The duplexer 211 is disposed on a signal line connecting the upward directivity antenna 21 with the radio receiver 51, and connects the radio receiver 51 with the divider 204, as well. The duplexer 212 is disposed on a signal line connecting the downward directivity antenna 22 with the radio receiver 52, and connects the radio receiver 52 with the divider 205, as well. The duplexer 213 is disposed on a signal line connecting the upward directivity antenna 23 with the radio receiver 53, and connects the radio receiver 53 with the divider 204, as well. The duplexer 214 is disposed on a signal line connecting the downward directivity antenna 24 with the radio receiver 54, and connects the radio receiver 54 with the divider 205, as well.

In addition to the above, based on the receiving signals, the selection-synthesis receiving unit 55 selects either the upward or the downward, or both the tilt-angle directivities; and simultaneously with this, in order to select either the upward or the downward, or both the tilt-angle directivities with respect to the transmitting signals, the unit 55 gives instructions of the selection to the selecting-transmitting unit 201 in the transmitting device 200.

In the next place, a transmitting operation of the radio communications apparatus 4 is described.

When transmitting signals are generated to transmit to a communications party in the radio communications apparatus 4, the transmitting signals will be outputted by the selecting-transmitting unit 201, either to the radio transmitter 202 or to the radio transmitter 203, or to both. To which way the signals are outputted follows an instruction given from the selection-synthesis receiving unit 55.

That is to say, when the selection-synthesis receiving unit 55 selects the upward directivity based on the receiving signals, in terms of the transmitting signals, an instruction signal for selecting the upward directivity is transmitted from the selection-synthesis receiving unit 55 to the selecting-transmitting unit 201, so that, following this instruction signal, the selecting-transmitting unit 201 selects the upward directivity. In this case, the transmitting signals will be outputted from the selecting-transmitting unit 201 to the radio transmitter 202. The transmitting signals from the selecting-transmitting unit 201 undergo frequency-conversion in the radio transmitter 202. The transmitting signals from the radio transmitter 202 are distributed by the divider 204, to the upward directivity antenna 21 and the upward directivity antenna 23. The above-distributed transmitting signals are radio-transmitted from the upward directivity antenna 21 by way of the duplexer 211, and from the upward directivity antenna 23 by way of the duplexer 213, respectively. The radio-transmitted signals are synthesized in midair, and are transmitted to a communications party.

Similarly to the above, when the selection-synthesis receiving unit 55 selects the downward directivity based on the receiving signals, also in terms of the transmitting signals, an instruction signal for selecting the downward directivity is transmitted from the selection-synthesis receiving unit 55 to the selecting-transmitting unit 201, so that, following this instruction signal, the selecting-transmitting unit 201 selects the downward directivity. In this case, the transmitting signals will be outputted from the selecting-transmitting unit 201 to the radio transmitter 203. The transmitting signals from the selecting-transmitting unit 201 undergo frequency-conversion in the radio transmitter 203. The transmitting signals from radio transmitter 203 are distributed by the divider 205, to the downward directivity antenna 22 and the downward directivity antenna 24. The above-distributed transmitting signals are radio-transmitted from the downward directivity antenna 22 by way of the duplexer 212, and from the downward directivity antenna 24 by way of the duplexer 214, respectively. The radio-transmitted signals are synthesized in midair, and are transmitted to a communications party.

Moreover, based on the receiving signals, when the selection-synthesis receiving unit 55 selects the upward and downward directivities, both signals from the two systems, that is, the upward directivity and the downward directivity described above are radio-transmitted together.

In this way, based on the receiving signals, by applying the tilt-angle directivities also to the transmitting signals to the same communications party that has originated the receiving signals, radio signals can be efficiently transmitted to the communications party.

### Embodiment 5.

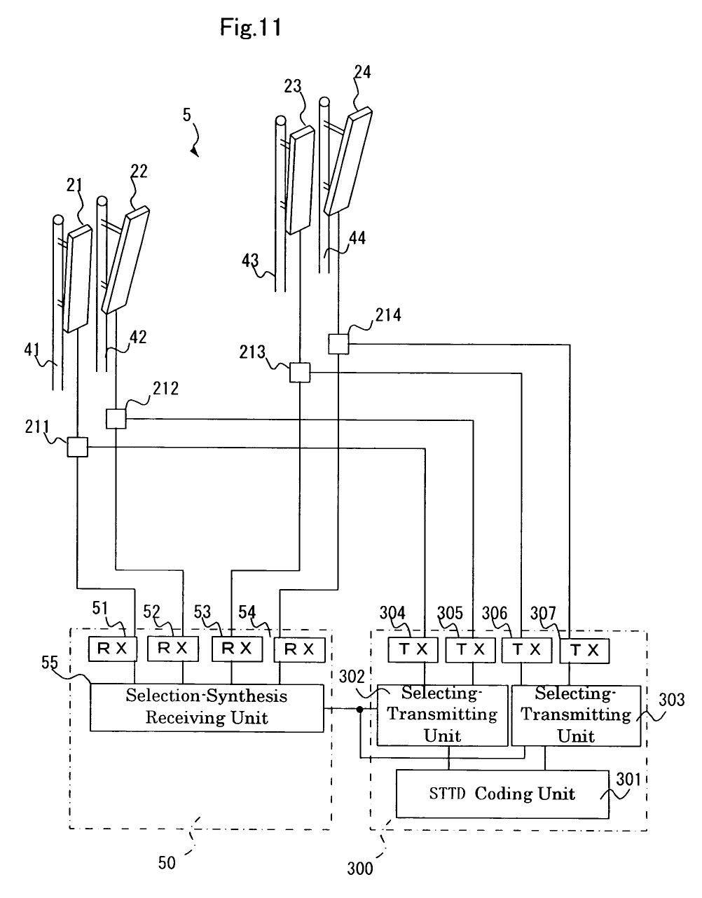

FIG. 11 is a diagram showing a schematic configuration of a radio communications apparatus in Embodiment 5 of the present invention. The radio communications apparatus 5, in the radio communications apparatus 4 shown in FIG. 10, replaces the transmitting device 200 with a transmitting device 300. For the same configurations in the radio communications apparatus 4, the same reference numerals and symbols are designated and their explanation is omitted; thus, explanations are given as below to other configurations that differ from those of the radio communications apparatus 4.

The transmitting device 300 comprises an STTD (space-time block-coding transmit-diversity) coding unit 301, selecting-transmitting units 302 and 303, and radio transmitters (TX) 304 through 307. The STTD coding unit 301 simultaneously generates one transmitting signal and the other transmitting signal that undergoes time-sequence alteration, positive-negative polarities inversion, and complex conjugating with respect to the one transmitting signal; the one is outputted to the selecting-transmitting unit 302, and the other to the selecting-transmitting unit 303. By this way, space diversity has been combined with time diversity, thus space-time diversity can be realized.

Following an instruction given from the selection-synthesis receiving unit 55 in the receiving device 50, the selecting-transmitting unit 302 selects either upward or downward, or both tilt-angle directivities; baseband transmitting signals are outputted to the radio transmitter 304 or the radio transmitter 305 corresponding to the selected tilt-angle directivity. Following an instruction given from the selection-synthesis receiving unit 55 in the receiving device 50, the selecting-transmitting unit 303 selects either upward or downward, or both tilt-angle directivities; baseband transmitting signals are outputted to the radio transmitter 306, or to the radio transmitter 307, or to the both corresponding to the selected tilt-angle directivity or directivities. In this way, in vertical directions, radio signals directed toward either or both of two tilt-angle ranges can be selectively transmitted.

Both the radio transmitters 304 and 305 convert the baseband transmitting signals given from the selecting-transmitting unit 302 into high-frequency-band signals capable of radio transmission. Similarly, both the radio transmitters 306 and 307 convert the baseband transmitting signals given from the selecting-transmitting unit 303 into high-frequency-band signals capable of radio transmission. The radio transmitter 304, which is connected to the upward directivity antenna 21 by way of the duplexer 211, corresponds to upward directivity. The radio transmitter 305, which is connected to the downward directivity antenna 22 by way of the duplexer 212, corresponds to downward directivity. The radio transmitter 306, which is connected to the upward directivity antenna 23 by way of the duplexer 213, corresponds to the upward directivity. The radio transmitter 307, which is connected to the downward directivity antenna 24 by way of the duplexer 214, corresponds to the downward directivity.

In addition to the above, based on the receiving signals, the selection-synthesis receiving unit 55 selects either the upward or the downward, or both the tilt-angle directivities; and simultaneously with this, in order to make a selection of either the upward or the downward, or both the tilt-angle directivities with respect to the transmitting signals, the unit 55 gives instructions of the selection to the selecting-transmitting units 302 and 303 in the transmitting device 300. Furthermore, when a plurality of the receiving signals is divided over the upward directivity and the downward directivity, a priorly selected tilt-angle directivity will be selected.

In the next place, a transmitting operation of the radio communications apparatus 5 is described.

When transmitting signals are generated to transmit to a communications party in the radio communications apparatus 5, based on the transmitting signals, two transmitting signals will be generated by the STTD coding unit 301. One of the two transmitting signals is outputted to the selecting-transmitting unit 302, and the other to the selecting-transmitting unit 303. The signal having been outputted to the selecting-transmitting unit 302 is outputted by the selecting-transmitting unit 302, to the radio transmitter 304, or to the radio transmitter 305, or to the both. To which way the signal is outputted follows an instruction given from the selection-synthesis receiving unit 55.

That is to say, when the selection-synthesis receiving unit 55 selects the upward directivity based on the receiving signals, in terms of the transmitting signals, an instruction signal to select the upward directivity is transmitted from the selection-synthesis receiving unit 55 to the selecting-transmitting unit 302, so that, following the instruction signal, the selecting-transmitting unit 302 selects the upward directivity. In this case, the transmitting signals will be outputted from the selecting-transmitting unit 302 to the radio transmitter 304. The transmitting signals from the selecting-transmitting unit 302 undergo frequency-conversion in the radio transmitter 304. The transmitting signals being outputted from the radio transmitter 304 are radio-transmitted from the upward directivity antenna 21, by way of the duplexer 211.

The other signal having been outputted to the selecting-transmitting unit 303 from the STTD coding unit is outputted by the selecting-transmitting unit 303, to the radio transmitter 306, or to the radio transmitter 307, or to both. Similarly to the case in the selecting-transmitting unit 302, to which way the other signal is outputted follows an instruction given from the selection-synthesis receiving unit 55.

Namely, when the selecting-transmitting unit 302 selects the upward directivity, similarly to say, the selecting-transmitting unit 303 also selects the upward directivity. In this case, the transmitting signals will be outputted from the selecting-transmitting unit 303 to the radio transmitter 306. The transmitting signals from the selecting-transmitting unit 303 undergo frequency-conversion in the radio transmitter 306. The transmitting signals being outputted from the radio transmitter 306 are radio-transmitted from the upward directivity antenna 23, by way of the duplexer 213.

Similarly to say, when the selection-synthesis receiving unit 55 selects downward directivity based on the receiving signals, also in terms of the transmitting signals, an instruction signal to select the downward directivity is transmitted from the selection-synthesis receiving unit 55 to the selecting-transmitting units 302 and 303, so that, following the instruction signal, the selecting-transmitting units 302 and 303 select the downward directivity. In this case, on one hand, the transmitting signals are outputted from the selecting-transmitting unit 302 to the radio transmitter 305, and, on the other hand, the transmitting signals are outputted from the selecting-transmitting unit 303 to the radio transmitter 307. The transmitting signals from the selecting-transmitting unit 302 undergo frequency-conversion in the radio transmitter 305, and the transmitting signals from the selecting-transmitting unit 303 undergo frequency-conversion in the radio transmitter 307. The transmitting signals being outputted from the radio transmitter 305 are radio-transmitted from the downward directivity antenna 22, by way of the duplexer 212. The transmitting signals being outputted from the radio transmitter 307 are radio-transmitted from the downward directivity antenna 24, by way of the duplexer 214.

Moreover, based on the receiving signals, when the selection-synthesis receiving unit 55 selects the upward and downward directivities, both signals from the two systems, that is, the upward directivity and the downward directivity described above are radio-transmitted.

In this way, based on the receiving signals, by applying the tilt-angle directivities also to the space-time transmit-diversity signals to the same communications party that has originated the receiving signals, radio signals can be efficiently transmitted to the communications party.

### Embodiment 6.

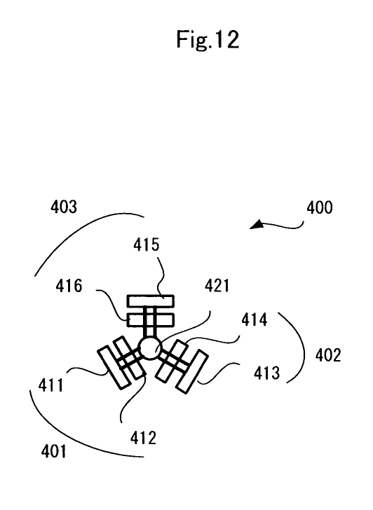

FIG. 12 is a view showing a schematic configuration of an antenna device in Embodiment 6 of the present invention. The antenna device 400, in the antenna device 70 shown in FIG. 7, replaces the two pairs of sector antennas allocated for each sector, with one pair of sector antennas for each sector.

The antenna device 400 comprises first sector antennas 401, second sector antennas 402, third sector antennas 403, and a mast 421. The first sector antennas 401 are configured with an upward directivity antenna 411 and a downward directivity antenna 412. The second sector antennas 402 are configured with an upward directivity antenna 413 and a downward directivity antenna 414. The third sector antennas 403 are configured with an upward directivity antenna 415 and a downward directivity antenna 416. The mast 421 commonly supports all of the upward directivity antennas 411, 413 and 415, and the downward directivity antennas 412, 414 and 416.

In this way, by supporting the first through third sector antennas corresponding to each sector on the common mast, as well as by supporting an upward directivity antenna and a downward directivity antenna being included in each sector antennas on the common mast, the single mast 421 supports all of the directivity antennas, so that installation space for the antenna device can be utilized efficiently.

Moreover, combining the antenna device 400 with the receiving devices in Embodiment 1 through 5, or with further the transmitting devices thereof, can configure a radio communications apparatus. In this case, although two pairs of sector antennas are provided for each sector in Embodiment 1 through 5, the antenna device 400 is provided with only one pair of sector antennas for each sector; thereby, configurations of the receiving device and the transmitting device can be simplified by that much.

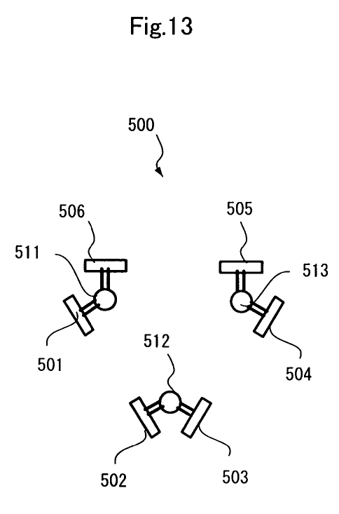

FIG. 13 is a view showing a schematic configuration of an antenna device related to a comparative example 2. The antenna device 500, in the antenna device 110 shown in FIG. 5, replaces the four sector antennas provided for each sector with two sector antennas for each sector.

The antenna device 500 includes first sector antennas 501 and 502, second sector antennas 503 and 504, third sector antennas 505 and 506, and masts 511, 512 and 513. The mast 511 commonly supports the first sector antenna 501 and the third sector antenna 506. The mast 512 commonly supports the first sector antenna 502 and the second sector antenna 503. The mast 513 commonly supports the second sector antenna 504 and the third sector antenna 505.

When the above-described antenna device 500 related to the comparative example 2 is compared with the antenna device 400 in Embodiment 6, that of the comparative example 2 performs space diversity by horizontally disposing two sector antennas for each individual sector; meanwhile, that of Embodiment 6 performs directivity diversity for each individual sector, therefore, installation-space utilizing efficiency is high in Embodiment 6.

What is claimed is:

1. An antenna device including two or more azimuthal range antennas for transmitting and receiving radio signals from azimuthal ranges being a full sweep divided into three or more, the azimuthal range antennas being rowed horizontally in each of the azimuthal ranges, the antenna device characterized in that
the azimuthal range antennas are tilt-angle directivity antennas directed toward two or more tilt-angle ranges.

2. The antenna device as set forth in claim 1,
further comprising a common mast for unitarily supporting the tilt-angle directivity antennas with a tilt-angle directivity antenna corresponding to an adjoining azimuthal range.

3. The antenna device as set forth in claim 1, wherein
the tilt-angle directivity antennas are configured in combination with individual antennas, of each directed toward each of the tilt-angle ranges.

4. The antenna device as set forth in claim 3,
further comprising a common mast for unitarily supporting the individual antennas.

5. The antenna device as set forth in claim 1, wherein
the tilt-angle directivity antennas further comprising two or more antenna elements being rowed in vertical directions; and
a phase conditioning unit for generating signals being directed toward the two or more tilt-angle ranges, by conditioning phase of the signals being outputted from said antenna elements, and by synthesizing thereof.

6. An antenna device including azimuthal range antennas for transmitting and receiving radio signals from azimuthal ranges being a full sweep divided into three or more, the azimuthal range antennas being directed toward each of the azimuthal ranges, the antenna device characterized in that:
the azimuthal range antennas are tilt-angle directivity antennas directed toward two or more tilt-angle ranges; and simultaneously, comprising
a common mast for unitarily supporting an azimuthal range antenna corresponding to an adjoining azimuthal range.

7. A radio communications apparatus including:
an antenna device having two or more azimuthal range antennas for transmitting and receiving radio signals from azimuthal ranges being a full sweep divided into three or more, and the azimuthal range antennas being rowed horizontally in each of the azimuthal ranges; and a receiving device for processing the signals having received by way of said antenna device; the radio communications apparatus characterized in that
the azimuthal range antennas are tilt-angle directivity antennas directed toward two or more tilt-angle ranges.

8. The radio communications apparatus as set forth in claim 7, wherein
the receiving device generates receiving signals either by selecting or synthesizing each of the signals having received by way of the two or more azimuthal range antennas being rowed horizontally in each of the azimuthal ranges.

9. The radio communications apparatus as set forth in claim 7, wherein
the receiving device generates receiving signals either by selecting or synthesizing each of the signals being directed toward the tilt-angle ranges.

10. The radio communications apparatus as set forth in claim 7,
further comprising a transmitting device for transmission-processing transmitting signals being transmitted by way of the antenna device.

11. The radio communications apparatus as set forth in claim 10, wherein
the transmitting device generates transmitting signals either by selecting or synthesizing each of the signals being directed toward the tilt-angle ranges.

12. The radio communications apparatus as set forth in claim 11, wherein
the transmitting device generates transmitting signals, according to receiving conditions of the signals from the receiving device being directed toward the tilt-angle ranges, either by selecting or synthesizing each of the signals being directed toward the tilt-angle ranges.

13. The radio communications apparatus as set forth in claim 10, wherein
the transmitting device individually transmits the signals in relation to the time-sequence having mutually replaced, by way of two or more azimuthal range antennas being rowed horizontally in each of the azimuthal ranges.
